(19) United States
(12) Patent Application Publication
(10) Pub. No.: US 2023/0400122 A1
(43) Pub. Date: Dec. 14, 2023

(54) VALVE AND METHOD FOR THE OPERATION

(71) Applicant: INNOVATHERM PROF. DR. LEISENBERG GMBH + CO. KG, Butzbach (DE)

(72) Inventor: Wolfgang Uhrig, Laubach (DE)

(21) Appl. No.: 18/207,947

(22) Filed: Jun. 9, 2023

(30) Foreign Application Priority Data
Jun. 13, 2022 (DE) 10 2022 114 841.6
Apr. 3, 2023 (DE) 10 2023 108 485.2

(51) Int. Cl. F16K 41/12; F16K 1/36; F23N 1/00

(52) U.S. Cl. CPC F16K 41/12; F16K 1/36; F23N 1/007; F23N 2235/14

(57) ABSTRACT

A valve (in particular—a gas valve), a fuel metering unit for a furnace utilizing such valve, and a method for operating the furnace and use of the valve. The valve includes a valve housing and a displaceable piston disposed in the valve housing and configured to be movable with respect to a valve seat of the valve housing in such a manner that two chambers of the valve can be shut off from each other. A piston sealing element for sealing the two chambers is realized between the piston and a piston guide element, the piston sealing element has a diaphragm realizing a sealing element of the piston sealing element.

The invention relates to a valve, in particular for gases, air, oxygen, fuel gas, natural gas, hydrogen or the like, to a fuel metering unit having a valve, and to a furnace and to a method for operating a furnace, the valve having a valve housing and a displaceable piston disposed in the valve housing, the piston being movable with respect to a valve seat of the valve housing in such a manner that two chambers are able to be shut off from each other, a piston sealing element for sealing the chambers being realized between the piston and a piston guide element.

Such valves are typically used for gaseous media and, thus, also for fuel metering units of furnaces. The known valves are realized with a piston which is longitudinally movable and often spring-loaded and which, in a rest position, seals a valve seat independently of a gas pressure due to a spring provided on the piston. The longitudinally movable piston is mounted in a guide, wherein a piston sealing element can be provided between the piston and a piston guide element. This is, in particular, the case if the piston is relieved from pressure, i.e. that active spaces of the piston are assigned to one of the chambers which are shut off from each other. This can, for example, be realized by means of a duct or a line which connects the active spaces to each other.

Since only relatively short piston strokes are necessary for a sufficient gas flow with such valves intended for gases, these valves can be operated with comparatively high switching frequencies. This is in particular the case if fuel gases, such as natural gas, are metered by means of a valve on a burner of a furnace. In this case, it is disadvantageous that, after a number of switching cycles, material particles accumulate in the area of the piston sealing element which can, for example, be realized by an O-ring or the like, said material particles accelerating wear of the seal. This disadvantageous effect occurs particularly quickly when pure gases are used as a medium as these do not contain components which contribute to a lubrication of the piston guide compared, for example, to compressed air. A comparable valve is known from EP 2 129 336 B1, for example.

Furthermore, such valves are typically only with restrictions suitable for metering different gases. For example, if fuel gases having a comparatively low heating value and/or fuel value are to be metered, a comparatively substantially larger amount of fuel gas in a combustion space of a furnace has to be metered. At the same time, the valve is to be operable with a high number of switching cycles so that the fuel gas can be metered as precisely as possible. Moreover, for safety reasons, the valve and/or the piston is/are to be capable of being closed very quickly.

Therefore, in order to change a furnace and/or a fuel metering unit to using a different gas as fuel, the valves intended for metering the gas need to be changed. Thus, the throughput of fuel has to be increased substantially if, for example, hydrogen is to be used as fuel. However, this is only possible by substantially enlarging a pressure and/or an operation pressure and/or an opening cross section of the valve.

Enlarging the opening cross section is i.a. possible by enlarging a piston stroke of the piston of the valve, wherein, in this case, this measure leads to an increased wear of the piston sealing element, which adversely affects the service life of the valve. Moreover, a piston stroke can be enlarged without substantial changes only if corresponding reserves exist with regard to a magnetic force.

The object of the invention at hand is therefore to propose a valve, a fuel metering unit, a furnace and a method for operating a furnace by means of which the most different gases can be metered and wear of a piston seal is reduced.

This object is attained by a valve having the features of claim 1, a fuel metering unit having the features of claim 15, a furnace having the features of claim 16, a method for operating a furnace having the features of claim 17 and a use of a valve having the features of claim 18.

The valve according to the invention, in particular for gases, air, oxygen, fuel gas, natural gas, hydrogen or the like, has a valve housing and a displaceable piston disposed in the valve housing, the piston being movable with respect to a valve seat of the valve housing in such a manner that two chambers are able to be shut off from each other, a piston sealing element for sealing the chambers being realized between the piston and a piston guide element, wherein the piston sealing element has a diaphragm realizing a sealing element.

The valve according to the invention is realized in such a manner that a plurality of different gases can be used for the metering. This is, in particular, achieved by the fact that a high number of switching cycles can be carried out by means of the valve during a large piston stroke. Thus, on the one hand, a large volume flow of gas can be metered due to the large piston stroke and, on the other hand, if this is desired, a comparatively small volume flow of gas can be metered, wherein the number of switching cycles per time unit is reduced in this case. Enlarging a valve seat is basically possible, however, thereby, a mass movable by the piston increases, which, in turn, limits a number of switching cycles. Moreover, a seal and wear of the valve seat are adversely affected when the pressure is increased to transport the respective gas. Since the piston is a pressure relief piston, the piston sealing element always seals the piston with respect to the piston guide element in such a manner that no gas can flow from one of the chambers into the other chamber via the piston guide element. According to the invention, the piston seal element may have a diaphragm realizing a sealing element. A diaphragm has the advantage that it does not have to be disposed directly between the piston and the piston guide element. Thus, the diaphragm can also be disposed on the valve housing or a side of the valve housing and in or on the piston in such a manner that no friction forces act on the diaphragm during a switching cycle of the piston, as would be the case with an O-ring, for example. In this case, a diaphragm is understood to mean a comparatively thin sealing element having a large sheet-like expansion in relation to a thickness. Since the diaphragm is realized to completely seal the chambers, a material of the diaphragm is impermeable to gas. By using the diaphragm as a sealing element, the piston sealing element is essentially independent of a length of a piston stroke and a possibly increased operating pressure of the valve with regard to its wear. At the same time, a valve seat, a piston diameter or the like do not necessarily have to be enlarged, which allows the valve to be designed for metering the most different gases with this simple design measure and which allows a change to a different gas type to be easily enabled and the valve to be used in many different ways. Moreover, since there is no longer a sealing element disposed between the piston and the piston guide element and/or the gap formed therebetween, wear is reduced because no friction occurs at the sealing element and the sealing element is frictionless and also no dirt adhering to the sealing element can negatively affect the friction properties of the piston guide element and the piston as well as an impermeability.

The sealing element can be elastic, preferably the sealing element can be realized as an elastomer seal or a rubber seal. Thus, in this case, the sealing element can follow the piston also during a movement of the piston and be deformed during this movement. If the sealing element is at least partially or completely made of rubber, in addition, a particularly good adjustment to possible clamping surfaces of the piston and of the piston guide element and/or to the valve housing is made possible such that a high impermeability of the piston sealing element can be achieved. Furthermore, since the sealing element is elastic, a spring movement of the sealing element can be used to return the piston. At the same time, the sealing element can also be dimensioned in such a manner that an elastic deformation of the sealing element does not produce substantial forces on a movement of the piston in the piston guide element. Consequently, the sealing element can be realized so as to be deformable during a movement of the piston. A deformation of the sealing element can in particular occur when the piston is positioned in an open position. In this case, the piston can also be moved into a shut-off position with the aid of the sealing element. In this case, a spring which may be provided for returning the piston can also be dimensioned smaller since a part of the required spring force for returning the piston can be produced by the sealing element. In this case, in a rest position of the piston, the sealing element can be disposed in a rest configuration, i.e. in an undeformed manner.

The sealing element can be circular-ring-shaped and/or disc-shaped. A sealing element realized as a disc or a ring can be produced particularly easy. The sealing element can also be disposed at any end of the piston.

The sealing element can be clamped and/or positively fixed, that is, positively mechanical engaged, for example form-fitted, to the piston and/or to the valve housing. Clamping the sealing element can not only fix the sealing element but also seal the sealing element on the valve housing and/or the piston. Additionally or alternatively to a clamping of the sealing element, also a positive fixation of the sealing element can be provided. For example, this can be realized by inserting the sealing element in a recess specifically provided therefor on the valve housing and/or the piston.

Furthermore, the sealing element can be realized with an inner edge and an outer edge, wherein the inner edge can be fixed to the piston and the outer edge can be fixed to the valve housing. Thus, the sealing element can be stretched between the inner edge and the outer edge in a mounting position and/or during a movement of the piston. This is particularly advantageous if comparatively high pressures have to be absorbed with the sealing element. However, the sealing element can also be realized in such a manner that a bead and/or a flange or a bellows which does not impede a movement of the piston is formed between the inner edge and the outer edge.

The sealing element can be realized with beads which can be formed on each of the inner edge and the outer edge of the sealing element. The beads can each have a round or another arbitrary cross section. Matching recesses in which the respective beads are inserted can be provided on the valve housing or in the piston. Thus, a more precise position of the sealing element can be ensured during a mounting and a slipping of the sealing element or a movement of the inner edge and the outer edge as a consequence of a movement of the piston can be prevented.

One of the chambers can be assigned to a line which can connect two active spaces of the piston permanently, wherein the active spaces can be realized in such a manner that the piston is relieved from pressure. Thus, the valve can be used as a safety valve for gaseous media. The pressure relief of the piston which can be achieved in this manner allows to move the piston into a shut-off position if a drive of the piston and/or a control device of the valve fail(s). It is essential for this purpose that, in the rest position of the piston, the valve seat seals independently of a gas pressure. The line for connecting the two active spaces of the piston can be realized in the piston, for example in the manner of a through bore in a longitudinal direction of the piston. Thus, the line can be particularly easily produced. It is also advantageous if the valve has a spring by means of which the piston can be positioned in a position. In case, a piston control and/or an actuator of the piston fail(s), the piston can, in this case, be moved into the shut-off position by means of the spring. Depending on the desired function of the safety valve which is realized in such a manner, conversely, a movement of the piston into the open position can also be provided. It is essential that the longitudinally movable piston is spring-loaded. Alternatively or additionally to a spring, a clamping force can also be generated by the diaphragm.

The valve can be realized to be useable for a pressure ≥1 bar, ≥2 bar, ≥3 bar or ≥4 bar. For example, for a pressure of ≥0 bar to ≥4 bar. Thus, the valve can be used for higher pressures such that hydrogen can be metered with the valve instead of natural gas, for example. Hydrogen has a comparatively lower fuel value and/or heating value than natural gas which requires a higher pressure to burn a comparatively larger amount of hydrogen. Thus, a use and/or change of a fuel metering unit to using, for example, hydrogen is made possible by means of the valve.

Alternatively or additionally, the valve can be realized to be useable for a pressure ≤1 bar, ≤2 bar, ≤3 bar, ≤4 or ≤5 bar. From the minimum and maximum pressures mentioned before, all conceivable ranges of a pressure can result for which the valve can be used.

The valve can be a directly controlled magnetic valve, wherein the piston can be actuated by means of an electromagnet. In comparison with a valve piston controlled by a servomotor or the like, a substantially higher proportion of switching cycles can be realized with the directly controlled magnetic valve and/or the electromagnet.

At least 100, 200, 300, 400 or 500 switching cycles per minute are capable of being realized with the valve. The valve can be realized with at least 500 million switching cycles per service life.

The valve can be realized with a piston stroke of 1, 2, 3 or 4 mm. Depending on the size of the piston stroke, a larger volume flow can be realized with a comparatively large piston stroke when the valve is opened.

A valve sealing element can be realized between the piston and the valve seat, wherein the two chambers can be sealed by means of said valve sealing element in a shut-off position, wherein the piston can be moved into the shut-off position by means of a spring. The valve sealing element can consist of an elastic material, such as rubber, and be realized as a disc or a ring. Furthermore, the valve sealing element can be fixed to the piston or on the valve seat.

To achieve an advantageous pressure relief of the valve, the piston sealing element and the valve sealing element can be realized and disposed in such a manner that active surfaces of the piston associated with the active spaces are essentially of the same size. In this case, the valve can selectively be subjected to a media pressure by the one or the other chamber. Also, the active surfaces can be dimensioned in such a manner that a restoring force of a spring for positioning the piston is at least partially taken into account.

The valve can be realized according to the requirements of DIN EN 161 in its latest version as at the priority date.

The fuel metering unit, the burner or the like comprises at least one valve according to the invention, preferably two valves according to the invention. In a combustion space of a furnace, by means of the fuel metering unit, fuel gas can be metered via a first valve and air or oxygen can be metered via a second valve. Both valves can be identical independent of the medium to be metered.

The furnace, the burning kiln, the tunnel furnace or the like comprises at least one fuel metering unit according to the invention. Preferably, the furnace comprises a plurality of fuel metering units. Gas can be blown into the furnace via the fuel metering unit. The furnace can be operated with a stoichiometric combustion by means of the fuel metering unit. Advantageous embodiments of a furnace are apparent from the descriptions of features of the dependent claims referring back to claim 1.

In the method according to the invention for operating a furnace, a burning kiln, a tunnel furnace or the like having at least one fuel metering unit having at least one valve, in a valve housing of the valve, a piston is moved with respect to a valve seat of the valve housing in such a manner that two chambers are shut off from each other, the chambers being sealed by means of a piston sealing element realized between the piston and a piston guide element, wherein a sealing element is realized by a diaphragm of the piston sealing element, the diaphragm being deformed during a movement of the piston. Regarding the advantages of the method according to the invention, reference is made to the description of advantages of the valve according to the invention. Further advantageous embodiments of the method are apparent from the descriptions of features of the dependent claims referring back to claim 1.

When the invention intends the use of a valve for metering hydrogen with a fuel metering unit of a furnace, a burning kiln, a tunnel furnace or the like, the valve has a valve housing and a displaceable piston disposed in the valve housing, the piston being movable with respect to a valve seat of the valve housing in such a manner that two chambers are able to be shut off from each other, a piston sealing element for sealing the chambers being realized between the piston and a piston guide element, the piston sealing element having a diaphragm realizing a sealing element. Regarding the advantageous effects of the use of the valve for metering hydrogen, reference is made to the description of advantages of the valve according to the invention. Further advantageous embodiments of the use are apparent from the descriptions of features of the dependent claims referring back to claim 1.

Below, a preferred embodiment of the invention is explained in more detail with reference to the accompanying drawings.

In the figures:

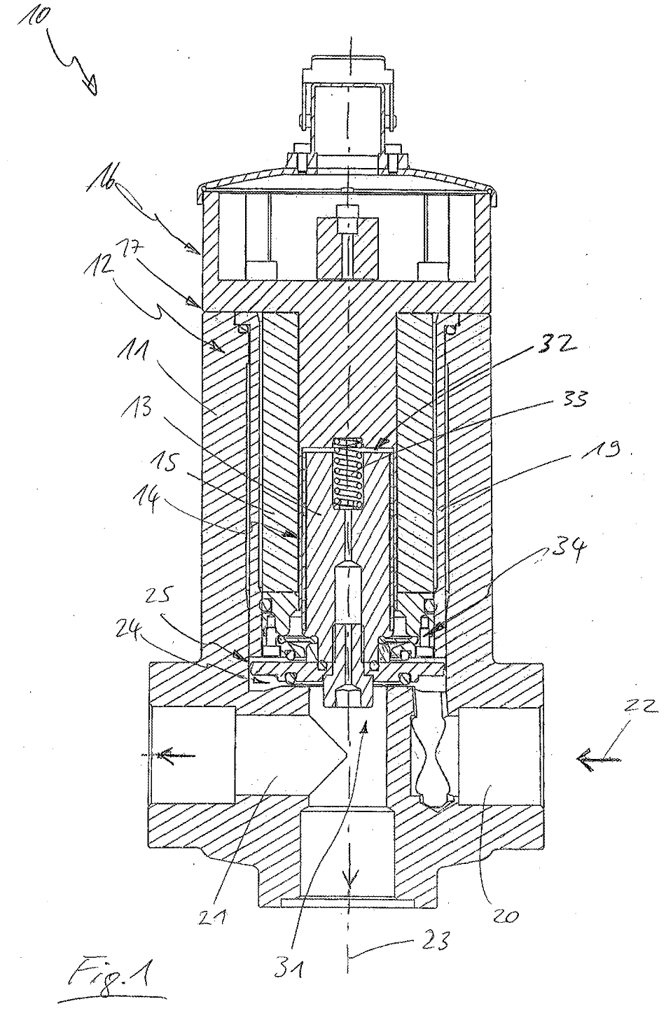

FIG. 1: shows a longitudinal section view of an embodiment of a valve;

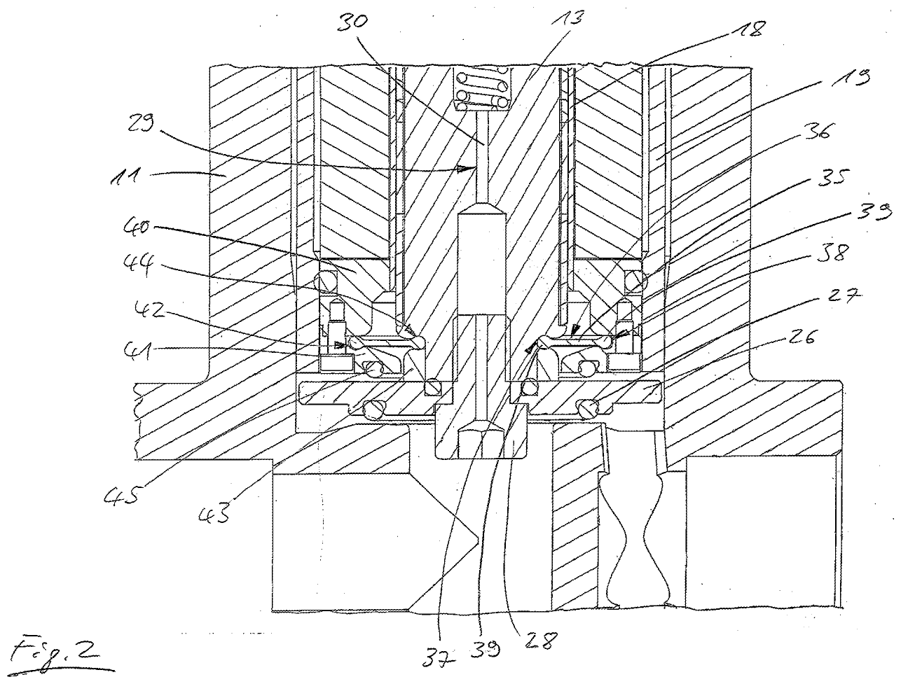

FIG. 2: shows an enlarged detailed view from FIG. 1.

A combination of FIGS. 1 and 2 shows a valve 10 having a valve housing 11 and an actuating device 12. Actuating device 12 comprises a piston 13, a sleeve-like piston guide element 14 for the longitudinally movable accommodation of piston 13 and an electromagnetic coil 15 and a holder 16 or magnetic core which accommodates electromagnetic coil 15 and seals valve housing 11 with a flange-like edge 17 and covers electromagnetic coil 15 and has an electrical connection space for energy. Furthermore, an annular slide bush 18 of steel and a sealing bush 19 are provided which at least partially surround holder 16 and/or piston guide element 14 and, thus, coaxially encompass piston 13. In this case, slide bush 18 has no sealing function. Sealing bush 19 closes a magnetic circle (not shown in the case at hand).

Valve housing 11 realizes a first chamber 20 and a second chamber 21 which have connection threads (not shown in detail in the case at hand) for the connection of media lines (not shown in the case at hand). In the exemplary embodiment, a preferred flow direction of a medium indicated with an arrow 22 from chamber 20 to chamber 21 is provided.

In valve housing 11, a valve seat 24 is realized coaxially to a longitudinal axis 23 of valve housing 11. Valve seat 24 is closeable by means of a valve sealing element 25. Valve sealing element 25 is formed by a disc 26 having a sealing ring 27 for sealing valve seat 24 and is fixed to piston 13. Furthermore, a through bore 30 realizing a line 29 is provided in piston 13 and on disc 26 and a screw 28 holding disc 26 on piston 13. Through bore 30 which is permeable to media connects a first active space 31 which is assigned to chamber 21 and thus located in chamber 21 to a second active space 32 of piston 13 formed between piston guide element 14 and piston 13. In second active space 32, a spring 33 is disposed coaxially to longitudinal axis 23 between piston 13 and piston guide element 14, said spring causing a return of piston 13 and of the open position (not shown in the case at hand) into a shut-off position of valve 10.

Since a possible pressure difference between first active space 31 and second active space 32 of piston 13 is essentially always balanced due to through bore 30, first active space 31 is sealed with respect to chamber 20 by means of a piston sealing element 34 disposed in the area of disc 26. This is necessary inasmuch as, in a shut-off position, the same pressure difference exists between chamber 20 and second active space 32 as between chamber 20 and chamber 21. In the partial open position of piston 13, which is shown in the case at hand, electromagnetic coil 15 is supplied with energy which results in a movement of piston 13 along longitudinal axis 23 in the direction of second active space 32 against spring 33. Thus, also disc 26 with sealing ring 27 is lifted off valve seat 24 which allows a flow of a medium from chamber 20 to chamber 21. In this case, piston 13 is moved relative to piston guide element 14.

Piston sealing element 34 has a diaphragm 35 realizing a sealing element 36. Sealing element 36 consists of rubber and is realized in a circular-ring-shaped manner with an inner edge 37 and an outer edge 38. An essentially circular bead 39 is realized at respective inner edge 37 and outer edge 38. The sealing element is clamped on piston 13 and valve housing 11 and/or on a disc-like ring 40 of valve housing 11 and/or positively connected to them. For this purpose, a clamping ring 41 is screwed on ring 40, clamping ring 41 being realized with a circumferential groove 42 for receiving bead 39. On clamping ring 41, an O-ring 45 in the manner of a stop is disposed which serves to reduce noise and with which disc 26 can come into contact when valve 10 is completely opened. Another clamping ring 43 is provided on piston 13, wherein, in this case, a circumferential groove 44, in which bead 39 on inner edge 37 of sealing element 36 is inserted and clamped there, is realized in piston 13. During a movement of piston 13, sealing element 36 and/or diaphragm 35 is/are now deformed, wherein inner edge 37 and outer edge 38 or respective beads 39 are not deformed as they are firmly fixed. Since diaphragm 35 and/or sealing element 36 can essentially freely deform and are, thus, not subjected to a friction force, wear of the sealing element can be reduced substantially. Furthermore, thereby, also a comparatively larger piston stroke is enabled, which allows a large volume flow to be metered by means of valve 10.

What is claimed is:

1. A fluidic valve comprising:
a valve housing and a displaceable piston disposed in the valve housing, the piston being movable with respect to a valve seat of the valve housing in such a manner as to shut off two chambers of the valve from each other,
a piston guide element,
a piston sealing element realized between the piston and the piston guide element and configured to seal the two chambers
wherein the piston sealing element has a diaphragm realizing a sealing element of the piston sealing element.

2. The fluidic valve according to claim 1, wherein
the sealing element of the piston sealing element is elastic.

3. The fluidic valve according to claim 1, wherein
the sealing element of the piston sealing element is configured to be deformable during a movement of the piston.

4. The fluidic valve according to claim 1, wherein
the sealing element of the piston sealing element is dimensioned to be circular-ring-shaped and/or disc-shaped.

5. The fluidic valve according to claim 1, wherein
the sealing element of the piston sealing element is clamped and/or positively fixed to the piston and/or to the valve housing.

6. The fluidic valve according to claim 1, wherein
the sealing element of the piston sealing element is realized with an inner edge and an outer edge, the inner edge being fixed to the piston (13) and the outer edge being fixed to the valve housing.

7. The fluidic valve according to claim 6, wherein
the sealing element of the piston sealing element is realized with beads that are formed on each of the inner edge and the outer edge of the sealing element.

8. The fluidic valve according to claim 1, comprising a line assigned to a chamber of the two chambers, said line connecting two active spaces (31, 32) of the piston permanently, the active spaces being realized in such a manner as to relieve the piston from pressure.

9. The fluidic valve according to claim 1, wherein
the valve is realized with a piston stroke of at least 1 mm, or at least 2 mm, or at least 3 mm, or at least 4 mm.

10. The fluidic valve according to claim 1, wherein
the valve is realized to be useable for a pressure ≥1 bar, ≥2 bar, or ≥3 bar, or ≥4 bar.

11. The fluidic valve according to claim 1, wherein
the valve is realized to be useable for a pressure ≤1 bar, ≤2 bar, ≤3 bar, ≤4 or ≤5 bar.

12. The fluidic valve according to claim 1, wherein
the valve is a directly controlled magnetic valve, the piston being actuatable by means of an electromagnet.

13. The fluidic valve according to claim 1, wherein
the valve is configured to implement at least 100 switching cycles/minute, or at least 200 switching cycles/minute, or at least 300 switching cycles/minute, or at least 400 switching cycles/minute, or at least 100 switching cycles/minute.

14. The fluidic valve according to claim 1, comprising
a valve sealing element realized between the piston and the valve seat,
wherein the two chambers are sealed by means of said valve sealing element in a shut-off position,
the piston being movable into the shut-off position by means of a spring.

15. A fuel metering unit comprising at least one valve according to claim 1.

16. A furnace at least one fuel metering unit according to claim 15.

17. A method for operating a furnace that contains at least one metering unit including at least one fluidic valve in a valve housing, the method comprising:
moving a piston of the at least one fluidic valve with respect to a valve seat to shut off two chambers of the valve from one another,
wherein the two chambers are being sealed with a piston sealing element that includes a sealing element of the piston sealing element and that is realized between the piston and a piston guide element,
wherein the sealing element of the piston sealing element is realized by a diaphragm of the piston sealing element, and
deforming the diaphragm during said moving.

18. The method for operating a furnace according to claim 17, further comprising:
metering hydrogen of the at least one metering unit of the furnace.
